(19) United States
(12) Patent Application Publication
(10) Pub. No.: US 2009/0231094 A1
(43) Pub. Date: Sep. 17, 2009

(54) Multiple vehicle remote keyless entry apparatus

(75) Inventors: Jeffrey D. Higgins, Dexter, MI (US); Douglas D. Turner, Lake Orion, MI (US); Donald V. Johnson, Howell, MI (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 12/075,939

(22) Filed: Mar. 14, 2008

(51) Int. Cl. H04B 1/02

(52) U.S. Cl. 340/5.64

(57) ABSTRACT

An apparatus and method for remotely controlling multiple control functions from a single remote entry device has a plurality of unique device transmission codes stored in the memory of the remote entry device. Each code is selectable to enable a single remote entry device to remotely control functions in a plurality of different devices, such as vehicles.

### BACKGROUND

The present disclosure relates, in general, to remote keyless entry systems and, particularly, to vehicle remote keyless entry systems.

Wireless key fobs are widely used for vehicle access and to remotely control vehicle functions, such as locking or unlocking doors, remote engine starting, flashing of emergency horns and lights, as well as to control, locate and provide information feedback between the driver and the vehicle.

Typically, one remote keyless entry (RKE) transmitter is used to control only one specific vehicle's functions. Each vehicle has its own separate fob with authentication codes, even if two vehicles owned by the same user are from the same vehicle manufacturer. This forces the user to either carry two separate key chains, each with a fob, or one large key chain with two fobs. Having to deal with two separate key chains is inconvenient for the driver. For example, if the driver grabs the wrong fob when he needs access to the other vehicle, significant frustration can be experienced. The one large key chain, on the other hand, is difficult for the user to carry in a pocket or purse, thus making this solution also undesirable.

It will be desirable to provide an RKE system which enables a single RKE fob to be used to control multiple vehicles or remote keyless devices.

### SUMMARY

A method and apparatus for activating a device control function from a portable remote entry device including a control to control activation of the device control functions by a controller configured for receiving wireless signals from the remote entry device and activating the selected vehicle control device.

The method includes the steps of activating control functions from a portable remote entry device incorporating a control to control activation of the control functions by a controller configured for receiving wireless signals from the remote entry device, storing a plurality of unique device identification codes in a memory in the remote entry device, selecting by the remote entry device one of the unique device identification codes, transmitting the selected unique identification code and a device control function selected by the remote entry device to a transmitter on the remote entry device, and transmitting the selected identification code and the control function to the controller for implementation of the selected control function.

The method further includes the steps of storing a plurality of unique transmission encryption algorithms in the memory of the remote entry device, and using one of the unique encryption algorithms to generate a unique transmission code.

The method may include the step of providing indication on the remote entry device of a selected one of the transmission codes.

The method may further include the step of providing the indicator with unique indications corresponding to each of the distinct identification codes stored in the memory.

The method may further include the step of constructing the remote entry device as a fob for a vehicle.

An apparatus for remotely activating device control functions, such as vehicle, garage door, and home functions, includes a controller adapted to be coupled to the device and operable to generate signals to control a device function, a portable remote entry device carrying at least one control function input, a control and a memory storing transmission encryption algorithms unique to each of a plurality of devices, a select input on the remote entry device for selecting one of the plurality of devices for signal transmission. The remote entry device control transmits a signal to the controller upon selection of one of the control function inputs, the signal including the unique identification code corresponding to the selected one of a plurality of devices.

The apparatus may further include an indicator carried on the remote entry device responsive to the control for providing a unique indication corresponding to the selected one of the plurality of devices for signal transmission by the control. The control of the remote entry device includes a program mode to learn new device transmission encryption algorithms.

The apparatus may further include a memory for storing a plurality of unique transmission encryption algorithms, each algorithm generating a unique device transmission code.

The apparatus may further include at least one LED displaying different colors or other Human Machine Interface indicators corresponding to each of the plurality of selectable devices.

### BRIEF DESCRIPTION OF THE DRAWING

The various features, advantages and other uses of the present invention will become more apparent by referring to the following detailed description and drawing in which:

FIG. 1 is a pictorial representation of a vehicle remote keyless entry system and single fob for two vehicles;

FIG. 2 is a block diagram of the control circuitry of the fob;

FIG. 3 is a flow chart of the normal operation mode of the fob; and

FIGS. 4A and 4B are flow charts depicting the program mode of the fob.

### DETAILED DESCRIPTION

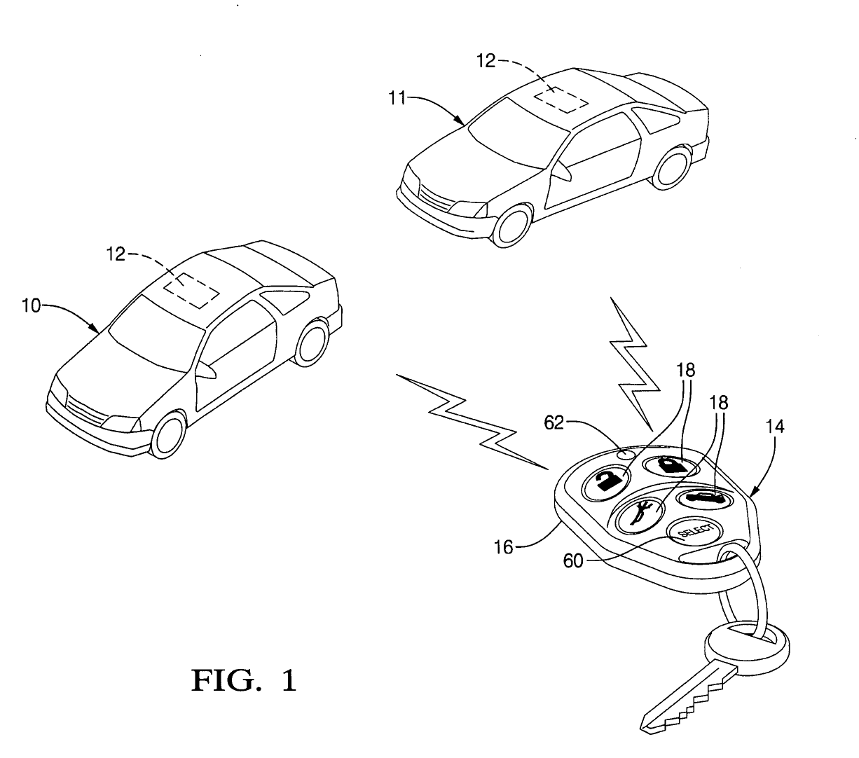

Referring now to the drawing, and to FIGS. 1, 2 and 3 in particular, there is depicted a plurality of vehicles, with two vehicles 10 and 11 shown by way of example. Each vehicle 10 and 11 has a remote keyless entry or RKE apparatus 12 mounted therein. A single wireless key fob 14 is associated with both RKEs 12 and is identifiable by a plurality of unique message and/or frequency matches to enable the fob 14 to transmit signals to both the RKEs 12 which are recognized by each RKE 12 as being valid for control functions in the vehicle 10 or 11, exclusively.

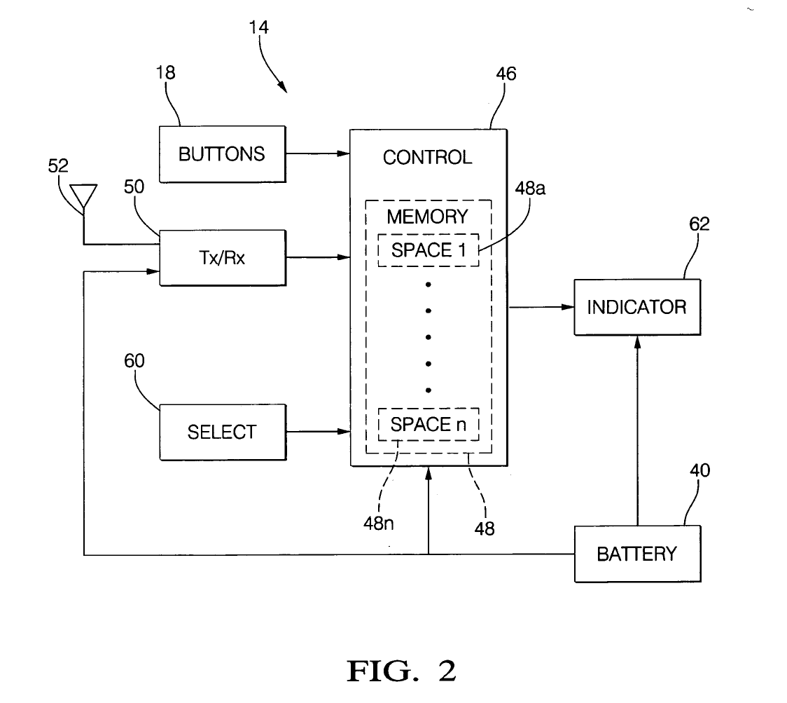

As shown in detail in FIG. 2, the fob 14 includes a control 46, which may be a processor based control executing a control program stored in a memory 48. One or more input members or buttons 18 are mounted on the housing 16 of the fob 14. The input members, such as switches or buttons 18 are each associated with a particular vehicle function, such as locking or unlocking the vehicle doors and/or trunk or hatch, lowering the vehicle windows, remotely starting the vehicle engine, flashing the vehicle's horn and/or lights, etc. A visual display, not shown, 62 may also be mounted in the fob housing 16 to display vehicle status or button 18 selection information.

It will be understood that the shape of the fob housing 16, the number and functions designated by the buttons 18, and the provision or non-provision of the display can be modified for any application; and any fob circuitry, housing shape, number and control function assigned to each button 18 may be employed

A power supply, such as a battery 40, is contained in the housing 16 for powering the components of the fob 14 as shown in FIG. 2. A transmitter, a transmitter/receiver, a transceiver or a transponder 50 is mounted in the housing 16 for transmitting data signals generated by the control 46 in response to depression or activation of one of the buttons 18. The transmitter 50 has a frequency of operation between 300 MHz to 450 MHz, for example only. Multiple transmitters/receivers may be implemented to support vehicles which use different operating frequencies and/or other transmission parameters, such as ASK vs FSK, for example.

The user depresses or activates one of the buttons 18 associated with the desired vehicle function that the user wishes to initiate. The input signal from the button 18 wakes up or activates the processor in the control 46 which outputs a data signal or data stream to the transmitter 50. The data stream may include a data preamble, the actual vehicle function command, i.e., unlock vehicle doors, etc., an optional rolling code for vehicle to vehicle security, and possibly one or more check bits. This signal is sent by the transmitter 50 through an antenna 52 to the RKE 12 where it is received by an RKE receiver through an antenna. The signal is demodulated by a vehicle RKE access controller which may also a microprocessor based controller. The controller outputs a signal to a vehicle function control device or to a vehicle body computer which implements the desired vehicle function.

To enable a single fob 14 to communicate with multiple vehicles 10 and 11, the fob 14 is provided with the ability to transmit two or more unique transmission IDs. The unique transmission ID will be generated through a distinct encryption algorithm each time a function command button 18 on the fob 14 is depressed or activated. The control 46 supports multiple encryption algorithms that will create independent codes for each respective messages. By supporting multiple encryption algorithms and/or transmitter frequencies, this method not only has the ability to transmit commands for different vehicles from the same manufacturer or vehicle supplier, but it also can be used across multiple manufacturers and supplier combinations.

The fob 14 has a human machine interface that conveys both the current mode of the fob 14 as well as a select input member or button 60 to enable the user to change the current mode. This interface also enables vehicle service personnel to change the current mode and select the proper encryption algorithm while programming the fob 14 to support additional vehicles.

An indicator means 62 is employed in the fob 14 to provide the current mode of one of the vehicles 10 and 11 during normal operation. For example only, the indicator 62 could be a multicolored LED where one color, such as red, represents the vehicle 10 and a different color, such as green, represents the second vehicle 11 other indicator means, such as multiple LEDs, one designated for each vehicle 10 or 11.

As shown in FIG. 2, the memory 48 includes a plurality of memory spaces 48A-48n which define the discrete or independent encryption algorithms for each of the vehicles 10 and 11. Additional memory spaces may be provided for storing programming encryption algorithms for other vehicles, garage door operators, home control functions, and other remote controlled devices

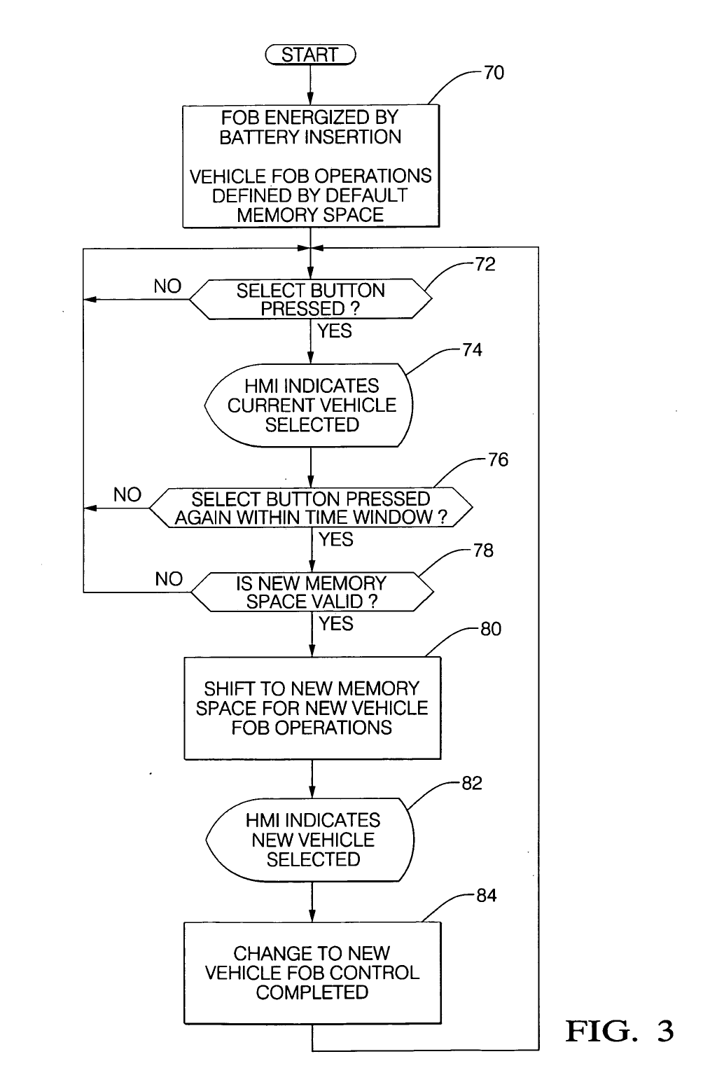

The normal operation mode of the fob 14 is shown in FIG. 3. Once initially activated by insertion of the battery 40 in step 70, the fob 14 operation is defined by a default memory space, such as space one, shown by reference number 48A.

When the select input member or button 60 is pressed in step 72, the indicator 62 in step 74 indicates the current vehicle 10 or 11 which is selected for signal transmission. If the select button 60 is pressed again within a time window preset time period, step 76, the control 48 checks if a new memory space 48A-48n is valid in step 78 as containing a programmed encryption algorithm for another vehicle.

If the new memory space is valid, the control 46 shifts to a new memory space for new vehicle fob operations in step 80. The indicator 62 now indicates in step 82 the new vehicle 10 or 11 which has been selected. The fob 14, in step 84, is now configured for communication with the desired vehicle 10 or 11. Any of the input members or buttons 18 can be depressed to cause activation of the selected vehicle function in the selected vehicle 10 or 11.

The indicator or LED 62 could display the color associated with the current selected vehicle 10 or 11 whenever one of the command input buttons 18 is pressed. This would enable the user or driver to immediately determine that he or she is transmitting command or control signals to the desired vehicle 10 or 11.

The same select button 60 and indicator 62 can be used during a program mode or cycle of the fob 14. In this mode, the indicator or LED 62 would change to a different color, number of flashes, or other visual or audio output methods to indicate the memory space 48A-48n which is about to be programmed. Once placed in the program mode, the indicator or LED 62 would indicate the current selected encryption algorithm selected by flashing a predetermined light sequence, such as a series of time-spaced short flashes to indicate vehicle 10 or a series of time-spaced, pair of quick pulses to indicate the other vehicle 11.

When the select button 60 is depressed, a message transmission to the vehicle 10 or 11 by the fob 14 will not occur and thus there will be no advancement of the associated unique vehicle ID rolling code. The rolling codes for each of the unique transmission IDs would only change when the message for the specific ID is transmitted. The fob 14 will next transmit the appropriate message of the indicated ID when the subsequent function button 18 presses i.e., lock, unlock, etc.

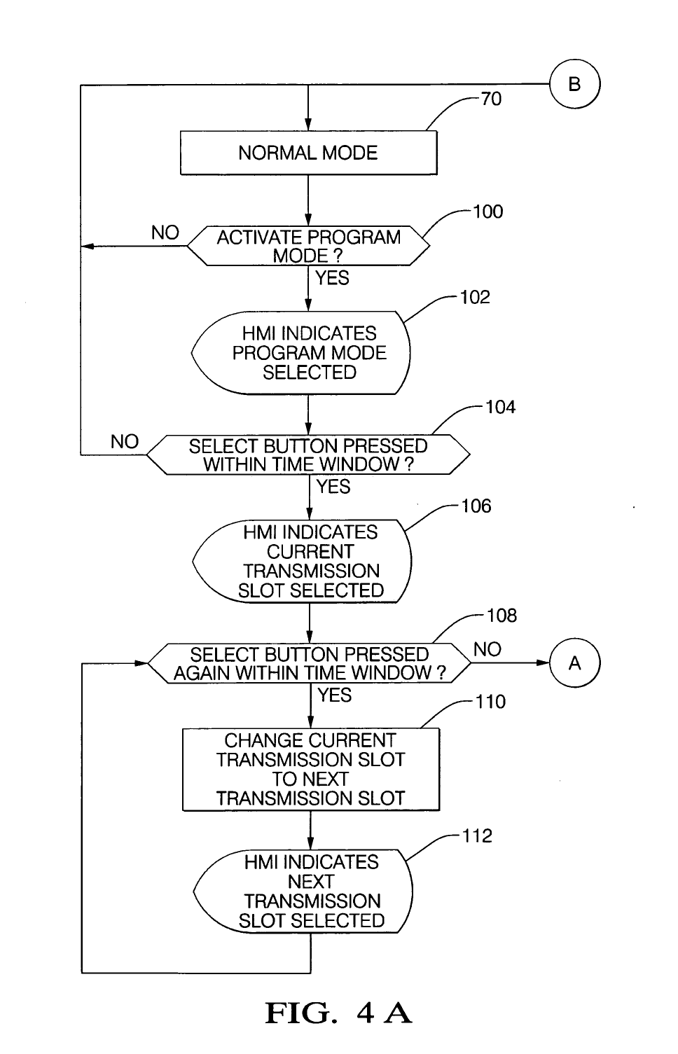

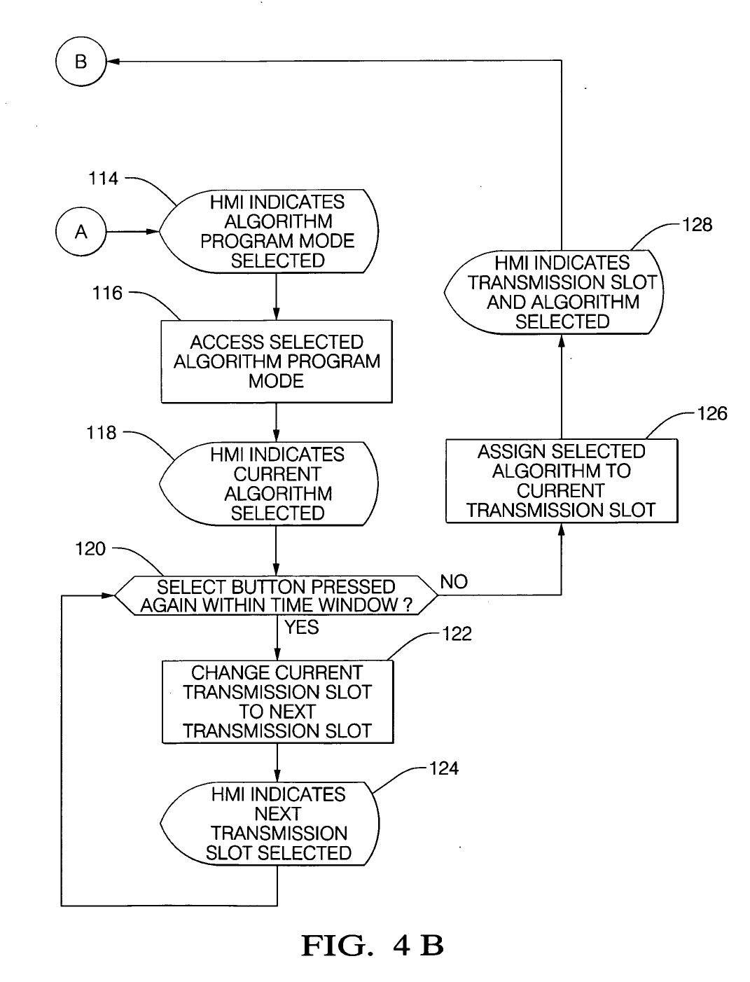

The program mode used by service personnel is depicted in FIGS. 4A and 4B.

The service personnel would also use the select button 60. In one aspect, the service personnel would use the select button 60 to change between the memory spaces 48A-48n associated with each possible vehicle. For example, the fob 14 could support four different vehicles. Hence, the memory 48 could have four separate memory spaces 48A., etc., one for each vehicle.

The same select button 60 would also be used to select the proper encryption algorithm to be associated with the memory space 48A-48n. Since the encryption algorithms are a set formula, the memory spaces 48A-48n could be used to store the rolling code generated by the algorithm. The encryption algorithms themselves can be stored in the memory 48 typically in a ROM portion of the memory 48. With proper hardware and software interfaces, the memory area used to contain the encryption algorithms could also be implemented with a programmable type of memory, such as flash memory, so that upgrades to the algorithms may be implemented after the fob 14 is delivered to the customer.

Referring now to FIGS. 4A and 4B, when entering the program mode, the select button 60 can be depressed for a predetermined amount of time, such as ten seconds, to activate the program mode shown in step 100. The indicator 62 then indicates in step 102, the selected program mode for vehicle 10 or 11. The select button 60 is then pressed within a predetermined time, such as within five seconds, as shown in step 104.

The indicator 62 by changing colors or number of flashes or other output methods indicates the current memory space 48A-48n which is selected in step 106. The select button 60 is then pressed within a predetermined time window, such as five seconds, as shown in step 108.

If the select button 60 is again pressed within the preset time window or period, the control 46 changes the selected memory space 48A-48n to the next memory space in step 110. The indicator 62 then changes color or state to indicate the next memory space in step 112.

Referring back to step 108, if the select button 60 is not pressed within the time window after the initial memory space is selected as indicated by the indicator 106, the indicator 106 will indicate that the algorithm program mode has been selected by a sequence of light flashes in step 114. The indicator 62 in step 116 also indicates by a series of flashes, for example, or a sequence of light color changes, that access to the selected algorithm program mode has been allowed. The indicator 62 indicates the current algorithm selected in step 118. If the select button 60 is pressed within a time window, within such as five seconds, in step 120, the control 46 changes the algorithm to the next algorithm in step 122. The indicator 62 then indicates the next algorithm selected in step 124.

Referring back to step 120, if the select button 60 is not pressed within the time window, the control 46 assigns the selected stored algorithm to the current memory space 48A-48n in step 126. The indicator 62 will then indicate the selected memory space 48A-48n and algorithm which had been selected in step 128 and control returns to the normal operation mode.

What is claimed is:

1. A method of activating control functions from a portable remote entry device incorporating a control to control activation of the control functions by a controller configured for receiving wireless signals from the remote entry device comprising the steps of:
storing a plurality of unique device identification codes in a memory in the remote entry device;
selecting by the remote entry device one of the unique device identification codes;
transmitting the selected unique identification code and a device control function selected by the remote entry device to a transmitter on the remote entry device; and
transmitting the selected identification code and the control function to the controller for implementation of the selected control function.

2. The method of claim 1 further comprising the steps of:
storing a plurality of unique transmission encryption algorithms in the memory of the remote entry device; and
using one of the unique encryption algorithms to generate a unique transmission code.

3. The method of claim 1 further comprising the step of:
providing indication on the remote entry device of a selected one of the transmission codes.

4. The method of claim 3 further comprising the step of:
providing the indicator with unique indications corresponding to each of the distinct identification codes stored in the memory.

5. The method of claim 1 further comprising the step of:
constructing the remote entry device as a fob for a vehicle.

6. An apparatus for activating control functions from a portable remote entry device incorporating a control to control activation of the control functions by a controller configured for receiving wireless signals from the remote entry device comprising the steps of:
means for storing a plurality of unique device identification codes in a memory in the remote entry device;
means for selecting by the remote entry device one of the unique device identification codes;
means for transmitting the selected unique identification code and a device control function selected by the remote entry device to a transmitter on the remote entry device; and
means for transmitting the selected identification code and the control function to the controller for implementation of the selected control function.

7. A device function remote control apparatus comprising:
a controller mounted adapted to be mounted in the device operable to generate signals to control a device function;
a portable remote entry device carrying at least one control function input, a control and a memory storing transmission encryption algorithms unique to each of a plurality of devices;
a select input on the remote entry device for selecting one of the plurality of devices for signal transmission; and
the remote entry device control transmitting a signal to the controller upon selection of one of the control function inputs, the signal including the unique identification code corresponding to the selected one of a plurality of devices.

8. The apparatus of claim 7 further comprising:
an indicator carried on the remote entry device responsive to the control for providing a unique indication corresponding to the selected one of the plurality of devices for signal transmission by the control.

9. The apparatus of claim 7 wherein the control further comprises:
a program mode to learn a new device transmission encryption algorithms.

10. The apparatus of claim 7 further comprising:
a memory for storing a plurality of unique transmission encryption algorithms, each algorithm generating a unique device transmission code.

11. The apparatus of claim 8 wherein the indicator comprises:
at least one LED providing different output indications corresponding to each of the plurality of selectable devices.

12. The apparatus of claim 7 wherein:
the remote entry device is a vehicle key fob.
